(19) United States
(12) Patent Application Publication
(10) Pub. No.: US 2015/0043585 A1
(43) Pub. Date: Feb. 12, 2015

(54) COMMUNICATION APPARATUS, COMMUNICATION METHOD, COMMUNICATION SYSTEM AND PROGRAM

(71) Applicants: Takahiro IIHOSHI, (US); Shuichi KARINO, (US); Akira TSUJI, (US)

(72) Inventors: Takahiro Iihoshi, Tokyo (JP); Shuichi Karino, Tokyo (JP); Akira Tsuji, Tokyo (JP)

(73) Assignee: NEC CORPORATION, Tokyo (JP)

(21) Appl. No.: 14/381,834

(22) PCT Filed: Feb. 27, 2013
(86) PCT No.: PCT/JP2013/001173

§ 371 Date: Aug. 28, 2014

(30) Foreign Application Priority Data
Feb. 29, 2012 (JP) 2012-042741

(51) Int. Cl. H04L 12/741

(52) U.S. Cl. CPC H04L 45/74
USPC 370/392

(57) ABSTRACT

A communication apparatus, comprises: a storage unit that stores a rule for identifying a packet and a process to be executed on a packet corresponding to the rule; a first unit that refers to a predetermined area in an incoming packet and searches the storage unit for a process corresponding to the incoming packet; and a second unit that determines a control apparatus to be queried for a process corresponding to the incoming packet from among a plurality of control apparatuses, based on the predetermined area.

### CROSS-REFERENCE TO RELATED APPLICATIONS

The present application claims priority from Japanese Patent Application No. 2012-042741 (filed on Feb. 29, 2012) the content of which is incorporated herein in its entirety by reference thereto. The present invention relates to a communication apparatus connected to a network, a communication method, a communication system and a program.

### TECHNICAL FIELD

### Background

In recent years, a technique called OpenFlow has been proposed. The OpenFlow is disclosed in Non Patent Literatures (NPLs) 1 and 2 and Patent Literatures (PTLs) 1 and 2. In the OpenFlow, a communication method between an OpenFlow switch (OFS) function and an OpenFlow controller (OFC), which is a control apparatus for the OFS function, is defined. These OFS and OFC are connected to each other via a control path called a secure channel. In addition, the OFS is controlled by a single OFC.

The OFS includes a flow table. In the flow table, at least a header field for identifying a flow of a packet and a process corresponding to the packet are paired and registered as an entry. The header field for identifying a packet is also referred to as a matching rule. The header field is formed by a plurality of tuples, and a wildcard can be designated for each tuple. By designating a wildcard, a flow range can be rep-resented as a union. For example, it is possible to designate only the source IP (Internet Protocol) address in the header field of a certain entry and to set wildcards in the other tuples. In such case, the set entry represents a union of all flows transmitted from the designated IP address. Namely, all the packets transmitted from the designated IP address correspond to the set entry, irrespective of the destinations of the packets.

In addition, the process corresponding to a packet is also referred to as an action. Examples of the action include at least forwarding to a designated port, forwarding to the OFC, forwarding back to an ingress port, and discarding. Forwarding to a designated port is used for forwarding a packet to a switch at the next hop. Forwarding to the OFC is mainly used for querying a packet processing method.

When receiving a packet, first, the OFS searches the flow table. If an entry matching the incoming packet exists, the OFS processes the packet, in accordance with an action in the matched entry. Since a priority can be set in an entry, if a packet matches a plurality of entries, the OFS uses an action in an entry with the highest priority.

If the flow table does not include any entries matching the incoming packet, the OFS queries the OFC for a process to be executed on the incoming packet. In such case, the OFS forwards part of the packet or the entire packet to the OFC via the secure channel. After receiving the query, as needed, the OFC adds an entry in the flow table and notifies the OFS of a processing method.

In addition, PTLs 3 and 4 disclose a network architecture including: a control apparatus that has a control function; and a switch that has a forwarding function and that is controlled by the control apparatus.

### CITATION LIST

### Patent Literature

PTL 1: Japanese Patent Kokai Publication No. JP2011-082834A
PTL 2: Japanese Patent Kokai Publication No. JP2011-101245A
PTL 3: Japanese Patent Kokai Publication No. JP2006-135971A
PTL 4: Japanese Patent Kokai Publication No. JP2006-135975A

### Non Patent Literature

NPL 1: Nick McKeown, and seven others, “OpenFlow: Enabling Innovation in Campus Networks,” [Searched on Jun. 28, 2011], Internet <URL: http://www.openflowswitch.org/documents/openflow-wp-latest.pdf>.
NPL 2: “OpenFlow Switch Specification Version 1.1.0 (Wire Protocol 0x01),” Dec. 31, 2009, [Searched on Feb. 16, 2012], Internet <URL: http://www.openflowswitch.org/documents/openflow-spec-v1.1.0.pdf>.

### SUMMARY

### Technical Problem

The entire disclosures of the above mentioned PTLs and NPLs are incorporated herein by reference thereto. The following analyses are given by the present invention.

The OpenFlow disclosed in NPLs 1 and 2 and PTLs 1 and 2 and the architecture disclosed in PTLs 3 and 4 are directed to a network system in which a single controller finely controls switch operations.

Thus, none of the literatures in the above Citation List discloses a situation where a plurality of controllers exist and a method for controlling a communication apparatus such as a switch or a communication terminal by such plurality of controllers.

### Solution to Problem

According to a first aspect of the present invention, there is provided a communication apparatus, comprising:

a storage means that stores a rule for identifying a packet and a process to be executed on a packet corresponding to the rule;

a first means that refers to a predetermined area in an incoming packet and searches the storage means for a process corresponding to the incoming packet; and

a second means that determines a control apparatus to be queried for a process corresponding to the incoming packet from among a plurality of control apparatuses, based on the predetermined area.

According to a second aspect of the present invention, there is provided a communication method, comprising:

by a communication apparatus, storing a rule for identifying a packet and a process to be executed on a packet corresponding to the rule in a storage means;

referring to a predetermined area in an incoming packet and searching the storage means for a process corresponding to the incoming packet; and

determining a control apparatus to be queried for a process corresponding to the incoming packet from among a plurality of control apparatuses, based on the predetermined area.

According to the present invention, there is also provided a packet forwarding apparatus, comprising:

a storage means that stores a rule for identifying a packet and a process to be executed on a packet corresponding to the rule;

a first means that refers to a predetermined area in an incoming packet and searches the storage means for a process corresponding to the incoming packet; and

a second means that determines a control apparatus to be queried for a process corresponding to the incoming packet from among a plurality of control apparatuses, based on the predetermined area.

According to a third aspect of the present invention, there is provided a communication system, comprising:

a plurality of control apparatuses; and

at least one communication apparatus, wherein

the at least one communication apparatus comprises:

a storage means that stores a rule for identifying a packet and a process to be executed on a packet corresponding to the rule;

a first means that refers to a predetermined area in an incoming packet and searches the storage means for a process corresponding to the incoming packet; and

a second means that determines a control apparatus to be queried for a process corresponding to the incoming packet from among a plurality of control apparatuses, based on the predetermined area.

According to a fourth aspect of the present invention, there is provided a program, causing a computer arranged on a communication apparatus to execute:

storing a rule for identifying a packet and a process to be executed on a packet corresponding to the rule in a storage means;

referring to a predetermined area in an incoming packet and searching the storage means for a process corresponding to the incoming packet; and

determining a control apparatus to be queried for a process corresponding to the incoming packet from among a plurality of control apparatuses, based on the predetermined area.

The program may also be provided as a computer product stored in a non-transitory computer-readable storage medium.

### Advantageous Effects of Invention

According to at least one of the aspects of the present invention, even when a plurality of controllers or control apparatuses controlling a communication apparatus such as a switch or a communication terminal exist, the communication apparatus can be controlled by the plurality of controllers or control apparatuses.

### BRIEF DESCRIPTION OF DRAWINGS

FIG. 1 illustrates a configuration example of a communication apparatus according to a first exemplary embodiment.

FIG. 2 is a flow chart illustrating an operation example according to the first exemplary embodiment.

FIG. 3 illustrates a configuration example of a communication system according to a second exemplary embodiment.

FIG. 4 illustrates a configuration example of a switch according to the second exemplary embodiment.

FIG. 5 illustrates a configuration example of the switch according to the second exemplary embodiment.

FIG. 6 illustrates a configuration example of a flow table according to the second exemplary embodiment.

FIG. 7 illustrates an entry edit command according to the second exemplary embodiment.

FIG. 8 illustrates a configuration example of the switch according to the second exemplary embodiment.

FIG. 9 illustrates additional entry information according to the second exemplary embodiment.

FIG. 10 is a flow chart illustrating an operation example according to the second exemplary embodiment.

FIG. 11 is a flow chart illustrating an operation example according to the second exemplary embodiment.

FIG. 12 is a flow chart illustrating an operation example according to the second exemplary embodiment.

FIG. 13 is a flow chart illustrating an operation example according to the second exemplary embodiment.

FIG. 14 illustrates a configuration example of a switch according to a third exemplary embodiment.

FIG. 15 illustrates a configuration example of a flow table according to the third exemplary embodiment.

FIG. 16 is a flow chart illustrating an operation example according to the third exemplary embodiment.

FIG. 17 illustrates a configuration example of a switch according to a fourth exemplary embodiment.

FIG. 18 illustrates a configuration example of a controller flow table according to the fourth exemplary embodiment.

FIG. 19 is a flow chart illustrating an operation example according to the fourth exemplary embodiment.

FIG. 20 is a flow chart illustrating an operation example according to the fourth exemplary embodiment.

FIG. 21 illustrates a configuration example according to a fifth exemplary embodiment.

FIG. 22 illustrates a configuration example according to the fifth exemplary embodiment.

FIG. 23 illustrates a configuration example according to the fifth exemplary embodiment.

FIG. 24 illustrates a configuration example according to the fifth exemplary embodiment.

FIG. 25 is a flow chart illustrating an operation example according to the fifth exemplary embodiment.

FIG. 26 illustrates a configuration example according to a sixth exemplary embodiment.

FIG. 27 illustrates a configuration example according to the sixth exemplary embodiment.

FIG. 28 illustrates a configuration example according to the sixth exemplary embodiment.

FIG. 29 illustrates a configuration example according to the sixth exemplary embodiment.

FIG. 30 is a flow chart illustrating an operation example according to the sixth exemplary embodiment.

FIG. 31 illustrates an operation example according to a seventh exemplary embodiment.

### DESCRIPTION OF EMBODIMENTS

Next, exemplary embodiments of the present invention will be described in detail with reference to the drawings.

### First Exemplary Embodiment

### Configuration

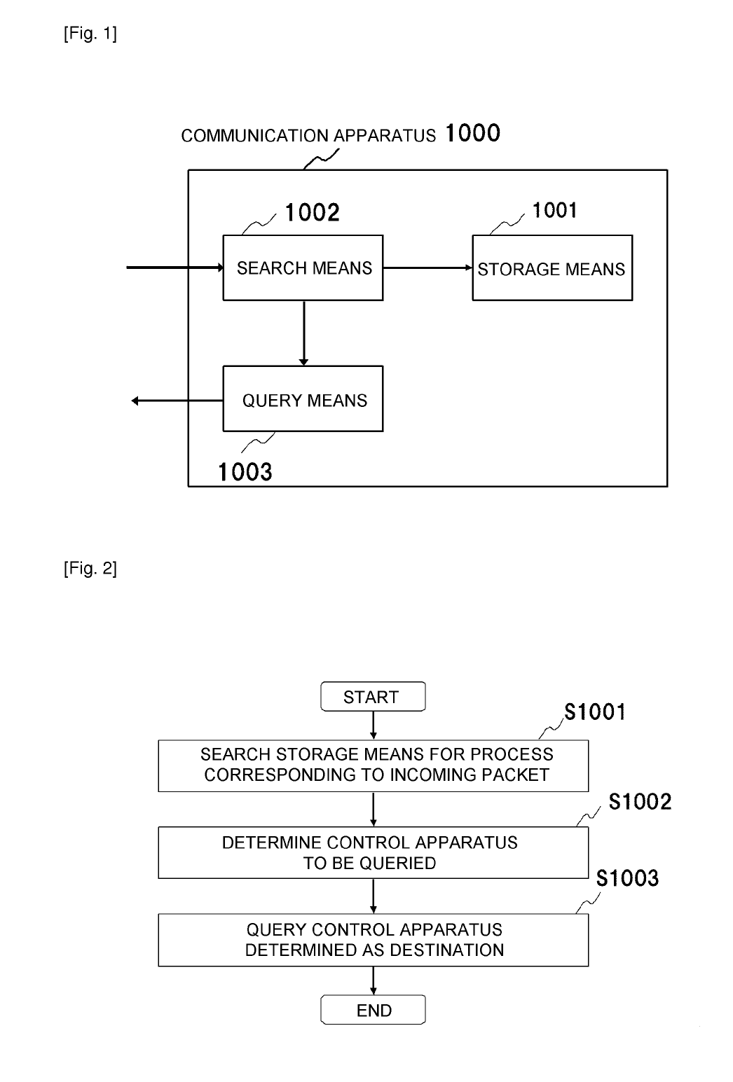

FIG. 1 illustrates a configuration example of a communication apparatus 1000 according to a first exemplary embodiment. In FIG. 1, the communication apparatus 1000 includes a storage means 1001, a search means 1002, and a query means 1003. In addition, the communication apparatus 1000 is connected to control apparatuses (not illustrated). The communication apparatus 1000 is controlled by the control apparatuses.

The storage means 1001 associates information for identifying a packet with a process corresponding to the packet and stores the associated information.

When receiving a packet, the search means 1002 searches the storage means 1001 for a process corresponding to an incoming packet.

If the process found by the search means 1002 is a query to a control apparatus, the query means 1003 executes the following operation. First, the query means 1003 determines a control apparatus to be queried, based on the entry in the storage means 1001 corresponding to the incoming packet. Next, the query means 1003 queries the control apparatus determined as the destination.

(Operation)

Next, an operation according to the first exemplary embodiment will be described with reference to a flow chart in FIG. 2.

First, the search means 1002 searches the storage means 1001 for a process corresponding to an incoming packet (step S1001).

Next, if the process found by the search means 1002 is a query to a control apparatus, the query means 1003 determines a control apparatus to be queried, based on the entry in the storage means 1001 corresponding to the incoming packet (step S1002).

Next, the query means 1003 queries the control apparatus determined in step S1002 as the destination (step S1003).

As described above, in the first exemplary embodiment, the communication apparatus 1000 includes the storage means 1001, the search means 1002, and the query means 1003. However, other than the communication apparatus, another communication device such as a communication terminal may include the above means.

(Advantageous Effects)

As described above, according to the first exemplary embodiment, the communication apparatus determines and queries a control apparatus for a process to be executed on an incoming packet. Consequently, the queried control apparatus can determine a process corresponding to the incoming packet. Thus, according to the first exemplary embodiment, even when a plurality of control apparatuses controlling a communication apparatus exist, since a single control apparatus controlling the incoming packet can be determined, control of a communication apparatus by a plurality of control apparatuses can be achieved.

### Second Exemplary Embodiment

### Configuration

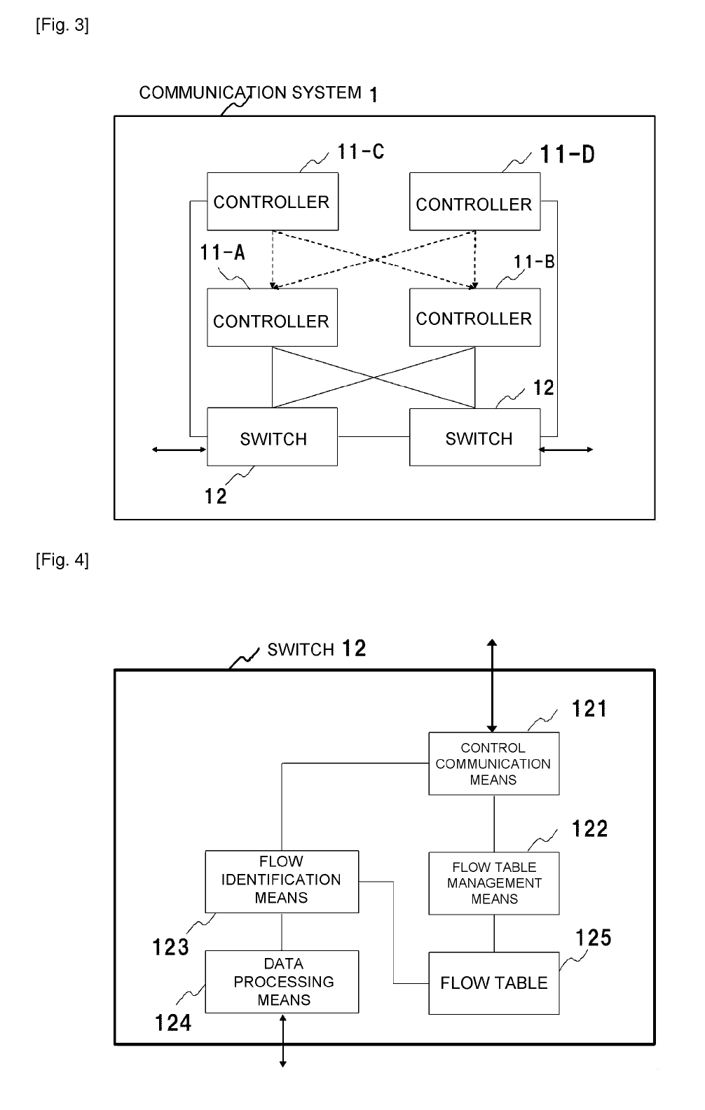

FIG. 3 illustrates a configuration example of a communication system 1 according to a second exemplary embodiment. The communication system 1 includes a plurality of controllers 11 and a plurality of switches 12 that are connected to a network (not illustrated). In FIG. 3, there are four controllers 11 (controllers 11-A to 11-D).

Hereinafter, unless these controllers need to be particularly distinguished, each of the four controllers will be referred to as a controller 11.

The switches 12 are connected to a plurality of controllers 11 via control paths. The controllers 11 are connected to the switches 12 controlled by the controllers 11 and exchange control messages with the switches 12.

In FIG. 3, there are two switches 12, and each of the switches 12 is connected to the controllers 11-A and 11-B. In addition, in FIG. 3, a connection relationship about the section from the controller 11-C to the controller 11-A is indicated by a dashed line and an arrow. Likewise, a connection relationship about the section from the controller 11-D to the controller 11-B is indicated by a dashed line and an arrow. This indicates that a certain controller can limit the communication range controlled by another controller.

FIG. 4 illustrates a configuration example of a switch 12. In FIG. 4, the switch 12 includes a control communication means 121, a flow table management means 122, a flow identification means 123, a data processing means 124, and a flow table 125.

The control communication means 121 is connected to controllers 11, the flow table management means 122, and the flow identification means 123. When receiving a control message from a controller 11, the control communication means 121 transmits a control instruction to the flow table management means 122. When the flow table management means 122 transmits a control result, the control communication means 121 transmits a control message to the controller 11, as needed.

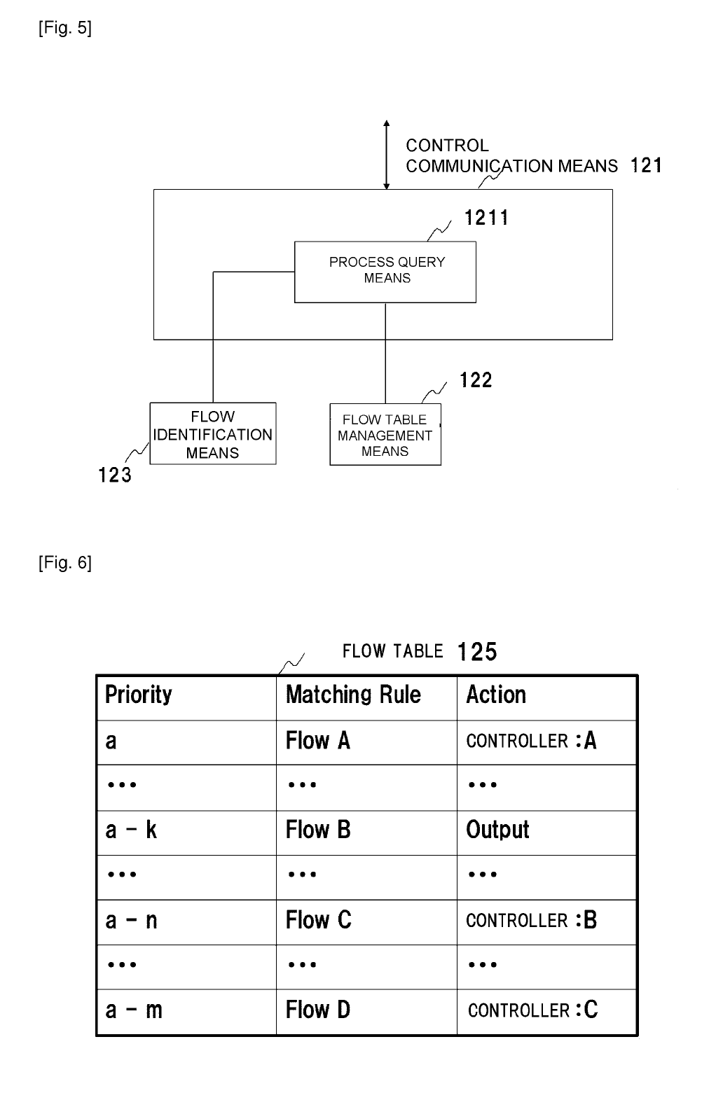

FIG. 5 illustrates a configuration example of the control communication means 121. In FIG. 5, the control communication means 121 includes a process query means 1211.

When receiving a query about a packet processing content and designation of a controller, the process query means 1211 queries a controller for a process.

The flow table management means 122 manages information described in the flow table 125. This flow table management means 122 will be described in detail below.

The flow identification means 123 identifies the flow to which a packet inputted to the data processing means 124 belongs. The flow identification means 123 is connected to the flow table 125. In addition, the flow identification means 123 searches the flow table 125 for a process corresponding to the identified flow.

The flow table 125 stores flow processing contents. For example, FIG. 6 illustrates a configuration of the flow table 125. An entry in the flow table 125 includes at least a priority, a matching rule, and an action. Priorities a, k, n, and m are natural numbers and satisfy the relationship k<n<m<a. Namely, in FIG. 6, entries are arranged in descending order of priority. As described in the above Background section, tuples such as an IP address or a MAC (Media Access Control) address are stored in a matching rule. In an action, a process to be executed on a packet matching the corresponding matching rule is described.

In the second exemplary embodiment, for a packet matching a matching rule, an action for querying a designated controller for a process can be registered. For example, if a packet belongs to flow A, a controller A is queried for a process. If a packet belongs to flow C, a controller B is queried for a process. In this way, for example, if a switch 12 receives a packet belonging to flow A, since the switch queries the controller A for a process, the controller A acquires an operation authority for flow A. A process described in the above Background section can be registered in an action. For example, if a packet belongs to flow B, the switch 12 forwards the packet to a designated port.

The data processing means 124 of the switch 12 receives a packet from another switch or the like connected to the switch 12. When receiving a packet, the data processing means 124 transmits part of the packet, the entire packet, or a copy of the packet to the flow identification means 123. The flow identification means 123 determines whether the packet matches any entry in the flow table 125, identifies the flow of the packet, and outputs an action. The data processing means 124 receives the action in the matched entry and processes the packet.

Next, a method in which a controller 11 sets an operation authority in an entry in the flow table 125 of a switch 12 will be described. The controller 11 describes operation authority information as additional information of a control message for instructing the switch 12 to operate an entry in the flow table 125. Alternatively, the controller 11 may transmit a special message for designating an operation authority to the switch 12, separately from a control message.

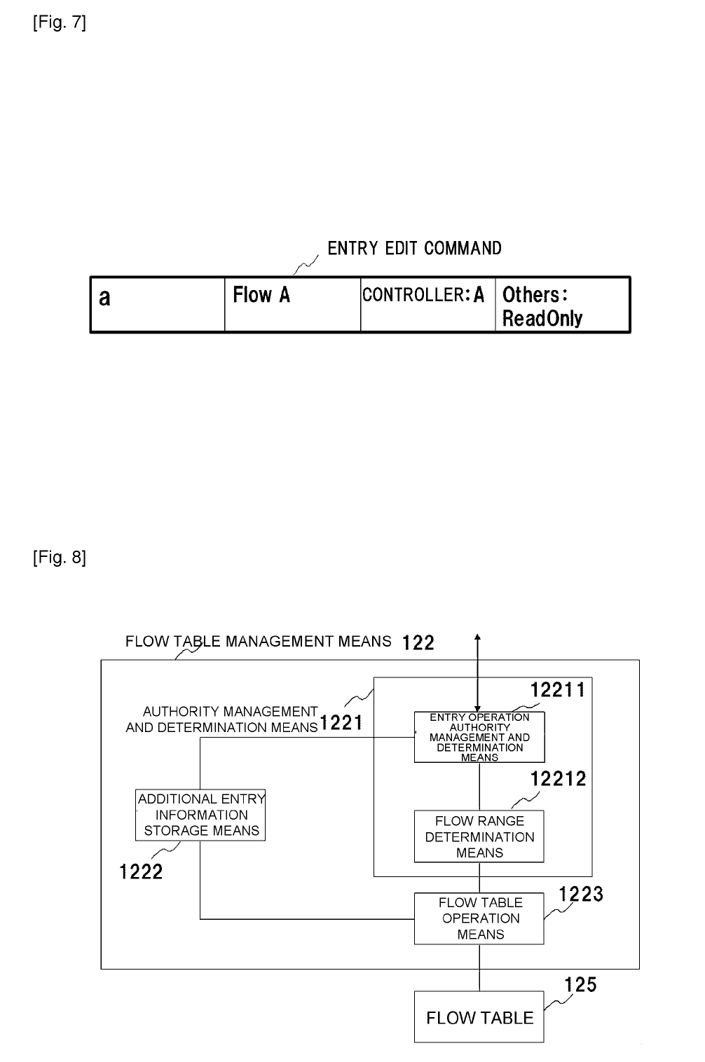

FIG. 7 illustrates an entry edit command transmitted from the controller 11 to the switch 12. An entry in FIG. 7 defines that, if the switch 12 receives a packet having “a” as the priority and “flow A” as the matching rule, the switch 12 queries the controller A for a process as the action. The controller 11 transmits the entry in FIG. 7 to the switch 12 and sets the entry in FIG. 7 in the flow table 125 of the switch 12. In addition, the field describing “Others: ReadOnly” indicates the operation authority in the entry in FIG. 7. The operation authority target can be designated as an individual controller such as the controller A, B, or the like or as a group of controllers. Alternatively, the operation authority target can be designated by a macro using a relationship between a controller to which the permission is designated and another controller. In FIG. 7, the controllers other than the controller to which the authority is designated are only permitted to execute reading only. The entry edit command in FIG. 7 gives the operation authority to the controller A. Thus, “Others: ReadOnly” indicates that the controllers other than the controller A are permitted to execute reading only.

Next, the flow table management means 122 will be described. As illustrated in FIG. 8, the flow table management means 122 includes an authority management and determination means 1221, an additional entry information storage means 1222, and a flow table operation means 1223.

First, the authority management and determination means 1221 includes an entry operation authority management and determination means 12211 and a flow range determination means 12212. The entry operation authority management and determination means 12211 is connected to the control communication means 121, the flow range determination means 12212, the additional entry information storage means 1222, and the flow table operation means 1223. The flow range determination means 12212 is connected to the flow table operation means 1223. In addition, the additional entry information storage means 1222 is connected to the flow table operation means 1223. The flow table operation means 1223 is connected to the flow table 125.

In response to an entry operation request from the controller 11 as illustrated in FIG. 7, the authority management and determination means 1221 determines the authority of the controller 11 and executes processing in accordance with the determination result.

The additional entry information storage means 1222 stores authority information corresponding to the entries in the flow table 125. For example, the authority information in an entry includes a permission uniquely defined for each controller and owner information (namely, information indicating a controller that has set the entry).

The entry operation authority management and determination means 12211 manages the entry operation authorities and determines whether to permit an operation in response to a request for operating an entry from a controller 11. When an operation authority in an entry in the flow table 125 is set via the control communication means 121, the entry operation authority management and determination means 12211 stores information about the operation authority in the additional entry information storage means 1222. When the controller 11 refers to/edits an entry via the control communication means 121, the entry operation authority management and determination means 12211 refers to the operation authority information in the additional entry information storage means 1222. In addition, if editing of an entry includes change of the matching rule, the entry operation authority management and determination means 12211 queries the flow range determination means 12212 and determines whether to permit the operation in view of the supplied determination result.

When the controller 11 registers an entry, the flow range determination means 12212 determines whether to permit the control operation of the controller 11. More specifically, the flow range determination means 12212 determines whether the control operation requested by the controller 11 falls within a flow range in which the control operation of the controller 11 is permitted. For example, the flow range determination means 12212 determines whether to permit the control operation of the controller 11, in view of an inclusion relation of matching rules (namely, a flow identification condition). For example, in the case of flows having a matching rule only determining whether a packet matches a predetermined source IP address (elements other than the source IP address are arbitrary (wildcards)), the flow range determination means 12212 determines that flows having a matching rule determining whether a packet matches the predetermined source IP address or a predetermined VLAN (Virtual Local Area Network) tag are included.

For example, it is possible to assume that a permissible flow range can be a union of matching rules of entries having actions for querying a certain controller. In addition, it is possible to assume that an invalid flow range includes entries that have actions for querying other controllers or that have matching rules with a priority higher than that of the entry used as the permissible range ground.

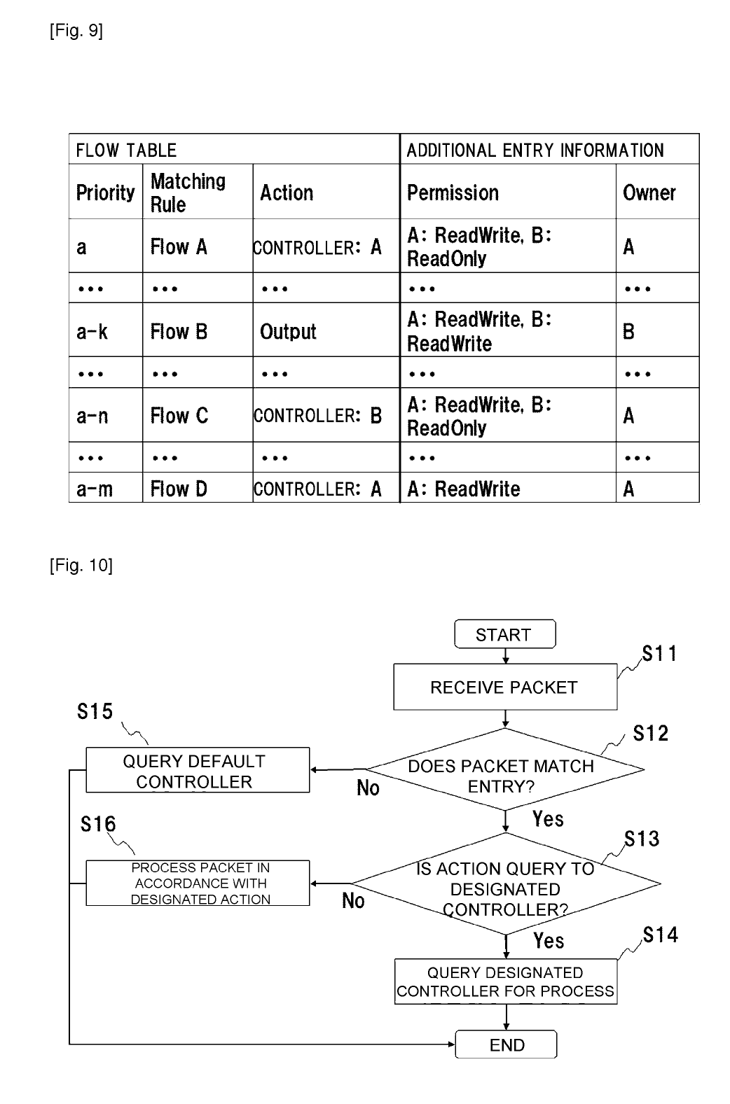

FIG. 9 illustrates entries in the flow table 125 and additional entry information stored in the additional entry information storage means 1222, the entries and the information being associated with each other. An example of the determination operation of the flow range determination means 12212 will be described with reference to FIG. 9. First, the first to third columns in the flow table represent priorities, matching rules, and actions, respectively. The first and second columns in the additional entry information represent operation authorities and owners, respectively, corresponding to the entries in the flow table 125. As in FIG. 6, in FIG. 9, the entries are arranged in descending order of priority. In FIG. 9, the controller A limits the flow range in which the controller B controls communication. “Controller: A” in the action column signifies that the switch 12 queries the controller A for a process when the switch 12 receives a packet matching flow A. There are two conditions that permit the controller B to register an entry having flow B as a matching rule. The first condition is that the flow range indicated by flow B is included in the flow range indicated by flow C, which is a matching rule in an entry of the controller A having an action for querying the controller B. The second condition is that the entry priority relationship satisfies a-n<a-k<a.

(Operation)

FIGS. 10 to 13 are flow charts illustrating operations of the communication system 1 according to the second exemplary embodiment. Next, operations according to the second exemplary embodiment will be described with reference to these flow charts.

FIG. 10 is a flow chart illustrating an operation executed when the switch 12 receives a packet according to the second exemplary embodiment.

First, the data processing means 124 receives a packet from another communication apparatus (not illustrated) on a network (step S11). Next, the flow identification means 123 determines whether the incoming packet matches a matching rule of an entry in the flow table 125 (step S12).

If the flow table 125 includes an entry matching the incoming packet, the flow identification means 123 determines whether the action in the matched entry is a query to a designated controller for a process (step S13).

If the flow identification means 123 determines that the action in the matched entry is a query to a designated controller for a process, the process query means 1211 queries the designated controller for a process (step S14).

If the flow identification means 123 determines that the action is not a query to a designated controller for a process, the data processing means 124 processes the packet in accordance with the action in the matched entry (step S16). For example, the data processing means 124 forwards the incoming packet to another communication apparatus or discards the incoming packet.

In step S12, if the flow identification means 123 determines that the packet does not match a matching rule of any entry in the flow table, the control communication means 121 queries a controller set as default for a process (step S15).

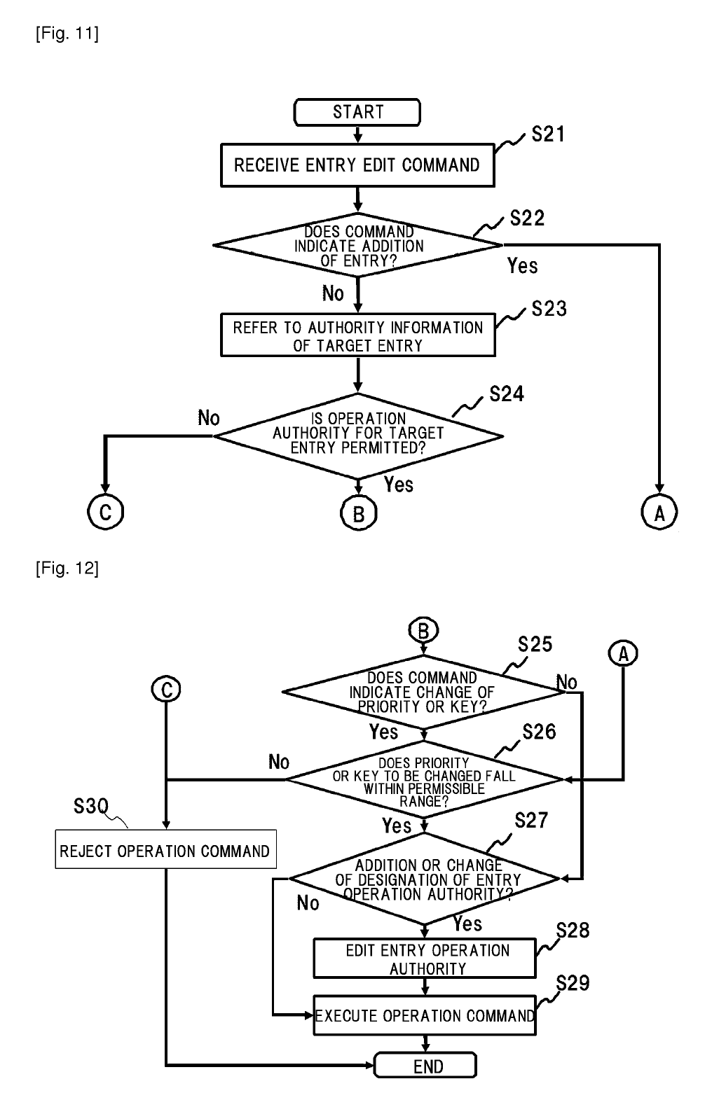

FIGS. 11 and 12 are flow charts illustrating an operation executed when the switch 12 receives an entry edit command from a controller 11.

First, the control communication means 121 receives an entry edit command from a controller 11 (step S21).

Next, the flow table management means 122 determines whether the received command indicates addition of an entry in the flow table 125 (step S22).

In step S22, if the flow table management means 122 determines that the received command does not indicate addition of an entry in the flow table, step S23 is executed. The entry operation authority management and determination means 12211 refers to the authority information stored in the additional entry information storage means 1222 (step S23). Next, the entry operation authority management and determination means 12211 determines whether the controller that has transmitted the command is permitted to edit the target entry (step S24).

In step S22, if the flow table management means 122 determines that the entry edit command indicates addition of an entry in the flow table, step S26 is executed. Step S26 will be described below.

In step S24, if the entry operation authority management and determination means 12211 determines that the controller that has transmitted the command is permitted to edit the target entry, the authority management and determination means 1221 executes step S25. The authority management and determination means 1221 determines whether the entry edit command indicates change of the priority or the matching rule in the entry (step S25).

In step S24, if the entry operation authority management and determination means 12211 determines that the controller that has transmitted the entry edit command is not permitted to edit the target entry, the flow table management means 122 rejects the operation command (step S30).

In step S25, if the authority management and determination means 1221 determines that the entry edit command indicates change of the priority or the matching rule in the entry, the flow range determination means 12212 executes step S26. The flow range determination means 12212 determines whether the priority or the matching rule in the entry changed as requested by the entry edit command falls within the range permitted for the requesting controller (step S26).

In step S26, if the flow range determination means 12212 determines that the priority or the matching rule in the entry changed as requested by the entry edit command falls within the range permitted for the controller, the entry operation authority management and determination means 12211 executes step S27. The entry operation authority management and determination means 12211 determines whether addition or change of designation of an entry operation authority is needed or whether no addition or change of designation of an entry operation authority is needed (step S27).

In step S27, if the entry operation authority management and determination means 12211 determines that addition or change of designation of an entry operation authority is needed, the entry operation authority management and determination means 12211 executes step S28. The entry operation authority management and determination means 12211 edits the entry operation authority in the additional entry information storage means 1222 (step S28). Next, the flow table operation means 1223 executes the operation command (step S29). In step S27, if the entry operation authority management and determination means 12211 determines that no addition or change of designation of an entry operation authority is needed, the process in step S28 is skipped. Instead, step S29 is executed.

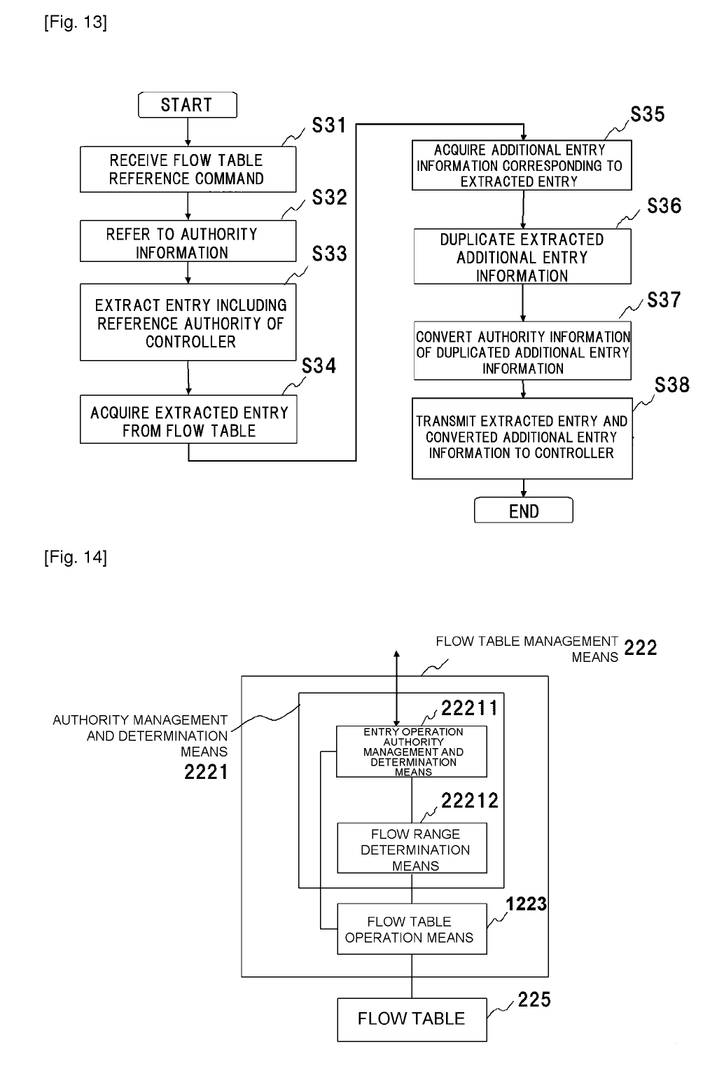

For example, to manage a switch 12, a controller 11 can transmit a command for referring to the flow table to a switch 12. This command will be hereinafter referred to as a flow table reference command. FIG. 13 is a flow chart illustrating an operation executed when a switch 12 receives a flow table reference command from a controller 11.

First, a switch 12 receives a flow table reference command from a controller 11 via the control communication means 121 (step S31).

Next, the entry operation authority management and determination means 12211 refers to the authority information stored in the additional entry information storage means 1222 (step S32).

After step S32, the entry operation authority management and determination means 12211 extracts an entry including reference authority of the controller that has transmitted the command (step S33).

The flow table operation means 1223 acquires the entry extracted in step S33 from the flow table 125 (step S34).

The entry operation authority management and determination means 12211 acquires additional entry information corresponding to the entry extracted in step S32 from the additional entry information storage unit 1222 (step S35).

Next, the entry operation authority management and determination means 12211 duplicates the additional entry information acquired in step S35 (step S36).

Next, the entry operation authority management and determination means 12211 converts the authority information in the additional entry information duplicated in step S36 into the authority of the controller requesting reference (step S37).

Finally, the control communication means 121 transmits the entry acquired in step S34 and the additional entry information converted in step S37 to the controller 11 requesting reference (step S38).

(Advantageous Effects)

As described above, in the communication system 1 according to the second exemplary embodiment, an action for designating one of the controllers 11 is used as an action in an entry in the flow table 125. In this way, a controller to be queried for packet processing can be distinguished per flow range. As a result, for example, it is possible to determine a single controller controlling a certain flow.

In addition, each switch 12 stores authority information about controllers 11 per entry and limits operations on the entries in the flow table 125. In this way, each switch 12 limits the flow ranges that can be controlled by the controllers 11. Thus, unintended overwriting of a control policy by a different controller can be prevented.

With the above operation, a switch 12 can directly be controlled by a plurality of controllers 11 based on a determined control range and authority range. Thus, according to the second exemplary embodiment, even when there are a plurality of controllers 11 controlling a switch 12, since it is possible to determine a single controller 11 controlling an incoming packet, control of a switch 12 by a plurality of controllers 11 can be achieved.

### Third Exemplary Embodiment

### Configuration

Next, a third exemplary embodiment will be described. The third exemplary embodiment is different from the second exemplary embodiment in a flow table management means 122 and a flow table 125 in a switch 12. Thus, the third exemplary embodiment will be described with a focus on the difference from the flow table management means 122, and the configurations and operations the same as those of the second exemplary embodiment will not be described.

FIG. 14 is a block diagram illustrating the flow table management means 222 according to the third exemplary embodiment. In FIG. 14, the flow table management means 222 includes an authority management and determination means 2221 and a flow table operation means 1222. The authority management and determination means 2221 includes an entry operation authority management and determination means 22211 and a flow range determination means 22212. The entry operation authority management and determination means 22211 is connected to the control communication means 121, the flow range determination means 22212, and the flow table operation means 1222.

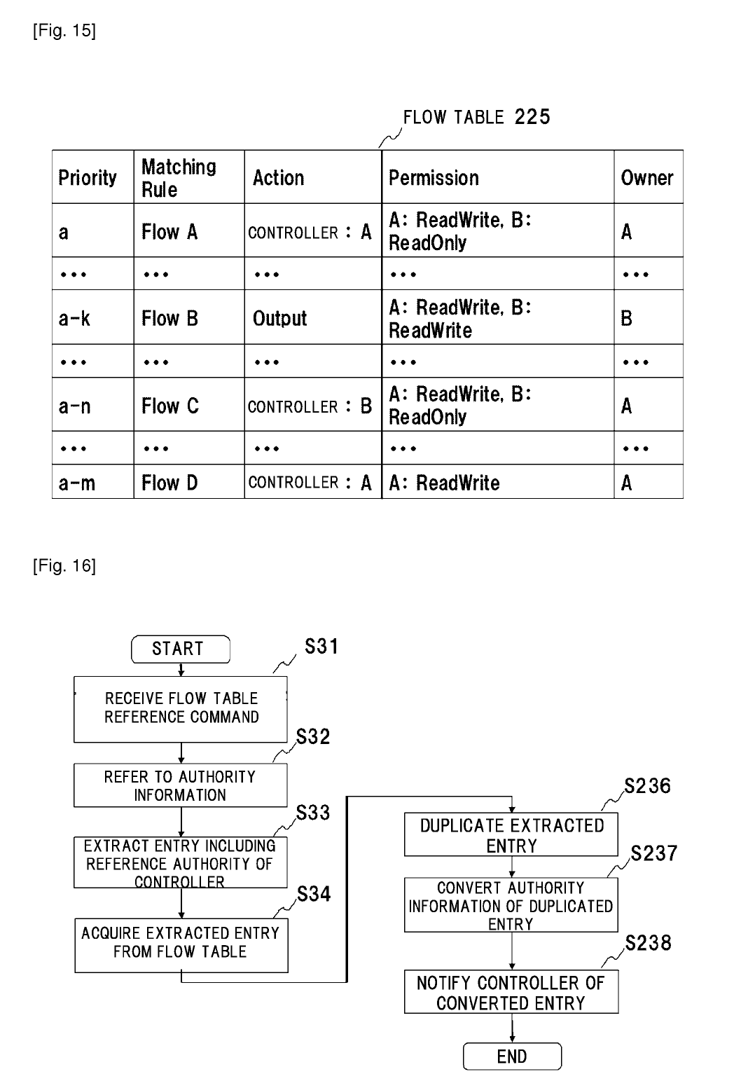

In addition, when compared with the flow table management means 122 according to the second exemplary embodiment, the additional entry information storage means 1222 is removed. In the third exemplary embodiment, the flow table 225 stores the information stored in the additional entry information storage means 1222 according to the second exemplary embodiment. FIG. 15 illustrates the flow table 225 according to the third exemplary embodiment. In FIG. 15, the flow table 225 stores authority information, in addition to the information stored in the flow table 125 according to the second exemplary embodiment.

(Operation)

When receiving an entry edit command from a controller 11, if additional entry information needs to be referred to or edited, the switch 12 according to the third exemplary embodiment simply needs to refer to or edit the flow table 225.

FIG. 16 is a flow chart illustrating an operation executed when the switch 12 according to the third exemplary embodiment receives a flow table reference command. The operation in FIG. 16 is different from the operation according to the second exemplary embodiment in FIG. 13 in steps after step S34. The other steps that are the same as those according to the second exemplary embodiment are denoted by the same reference characters as those in FIG. 13, and description thereof will be omitted.

The entry operation authority management and determination means 22211 duplicates the entry acquired in steps S33 and S34 (step S236).

Next, the entry operation authority management and determination means 22211 converts authority information of the entry duplicated in step S236 into authority of the controller requesting reference (step S237).

Finally, the control communication means 121 notifies the controller 11 requesting reference of the entry converted in step S237 (step S238).

(Advantageous Effects)

The communication system 1 according to the third exemplary embodiment provides advantageous effects similar to those provided by the communication system 1 according to the second exemplary embodiment. Namely, an action for designating one of the controllers 11 is used as an action in an entry in the flow table 225 according to the third exemplary embodiment. In this way, a controller to be queried for packet processing can be distinguished per flow range. As a result, for example, it is possible to determine a single controller controlling a certain flow.

In addition, each switch 12 stores authority information about controllers 11 per entry and limits operations on the entries in the flow table 225. In this way, each switch 12 limits the flow ranges that can be controlled by the controllers 11. Thus, unintended overwriting of a control policy by a different controller can be prevented.

With the above operation, a switch 12 can directly be controlled by a plurality of controllers 11 within a determined control range and authority range. Thus, according to the third exemplary embodiment, even when there are a plurality of controllers 11 controlling a switch 12, since it is possible to determine a single controller 11 controlling an incoming packet, control of a switch 12 by a plurality of controllers 11 can be achieved.

### Fourth Exemplary Embodiment

### Configuration

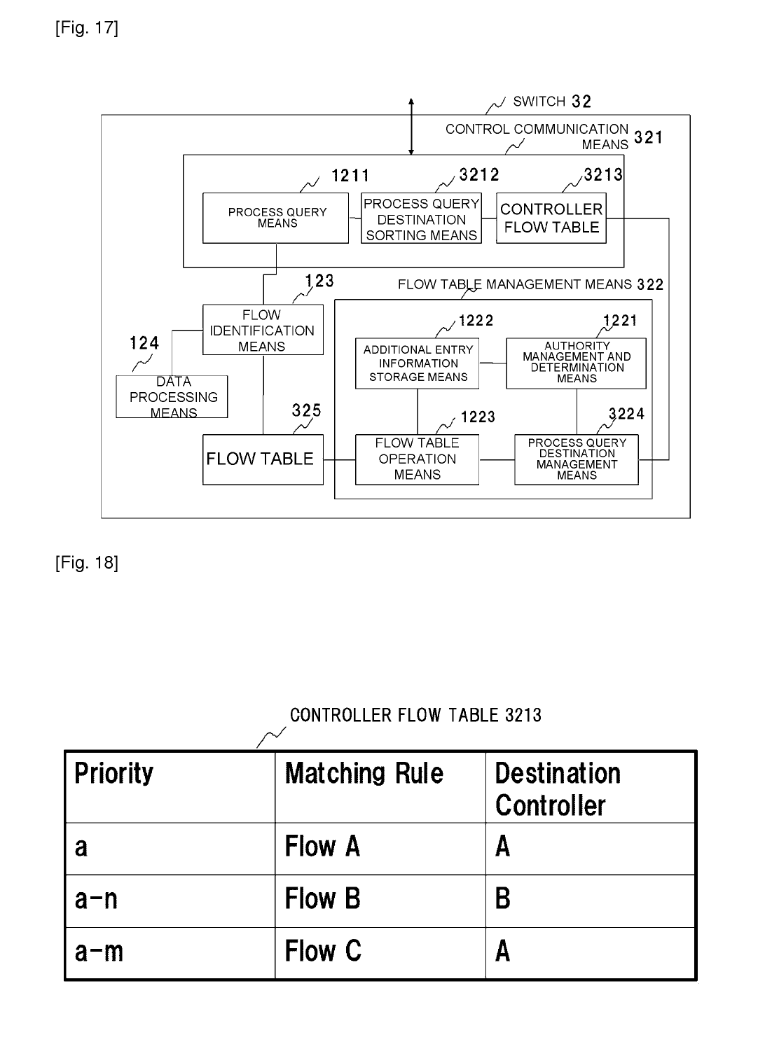

FIG. 17 illustrates a switch 32 according to a fourth exemplary embodiment. As illustrated in FIG. 17, the switch 32 according to the fourth exemplary embodiment is different from the second exemplary embodiment in a control communication means 321, a flow table management means 322, and a flow table 325. The other constituent elements are the same as those according to the second and third exemplary embodiments. In addition, the constituent elements the same as those according to the second exemplary embodiment are denoted by the same reference characters as those in FIG. 4, FIG. 5, and FIG. 8, and detailed description thereof will be omitted.

In the fourth exemplary embodiment, there is no need to register a query to a designated controller for a process as an action in the flow table 325. Such case in which a query to a designated controller for a process is not registered as an action in the flow table 325 will be described.

In the fourth exemplary embodiment, the control communication means 321 includes the process query means 1211, a process query destination sorting means 3212, and a controller flow table 3213. In addition, unlike the second exemplary embodiment, the flow table management means 322 according to the fourth exemplary embodiment includes a process query destination management means 3224.

Next, these newly-added elements according to the fourth exemplary embodiment will be described. First, the process query destination sorting means 3212 selects a controller 11 to be queried for a packet processing content. In addition, the process query destination sorting means 3212 converts an instruction for querying an arbitrary controller for a process into an instruction for querying a designated controller for a process.

FIG. 18 illustrates the controller flow table 3213. In FIG. 18, the controller flow table 3213 includes, as an entry, at least a priority, a matching rule, and an identifier of a destination controller. An arbitrary identifier may be used, as long as a controller can be uniquely defined by the identifier.

In addition, the process query destination management means 3224 manages process query destination sorting references and converts the action section in an entry.

(Operation)

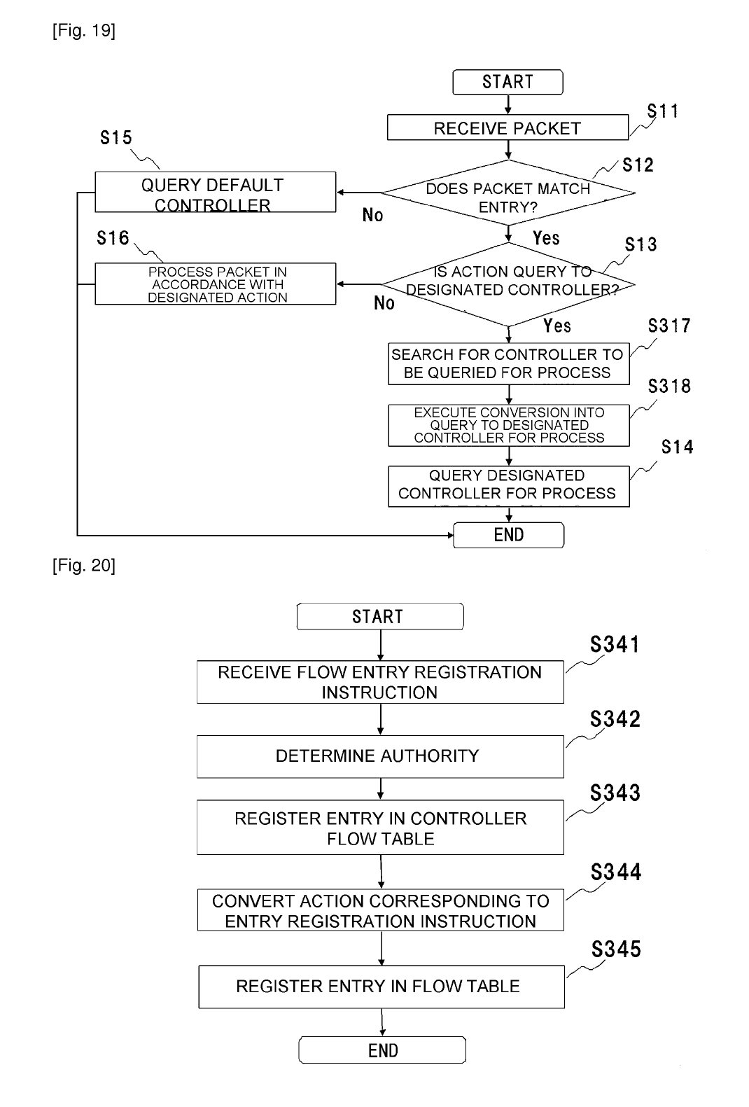

FIGS. 19 and 20 are flow charts illustrating operations of the switch 32 according to the fourth exemplary embodiment. Steps the same as those according to the second exemplary embodiment are denoted by the same reference characters as those in FIG. 10, and detailed description thereof will be omitted.

FIG. 19 is a flow chart illustrating an operation executed when the switch 32 receives a packet. First, the switch 32 receives a packet and determines whether the incoming packet matches a matching rule in an entry in the flow table (steps S11, S12).

In step S12, if the switch 32 determines that the incoming packet matches a matching rule in an entry in the flow table, the flow identification means 123 determines whether an action in the entry having the matched matching rule is a query to a controller for a process (step S13).

In step S13, if the flow identification means 123 determines that the action in the matched entry is a query to a controller for a process, step S317 is executed. The process query destination sorting means 3212 refers to the controller flow table 3213 to search for a controller to be queried for a process executed on the incoming packet (step S317). More specifically, the process query destination sorting means 3212 searches the controller flow table 3213 for an entry having a matching rule corresponding to the matching rule matching the incoming packet. The process query destination sorting means 3212 acquires a destination controller in the found entry as a query destination.

Next, the process query destination sorting means 3212 converts the query to an arbitrary controller for a process into a query to the found controller designated as the destination for a process (step S318).

Next, the process query means 1211 queries the designated controller for a process (step S14).

FIG. 20 is a flow chart illustrating an operation executed when the switch 32 is instructed by a controller 11 to register an entry for designating a process query destination. In the second and third exemplary embodiments, when the switch 12 receives an instruction for registering an entry, the switch 12 simply registers the entry in the flow table. However, in the fourth exemplary embodiment, the switch 12 also needs to register the entry in the controller flow table 3213.

First, the control communication means 321 receives an entry registration instruction for designating a process query destination from a controller 11 (step S341).

Next, the authority management and determination means 1221 determines the authority of the entry, as in the second exemplary embodiment (step S342).

Next, the process query destination management means 3224 registers the entry having a matching rule as a key and a controller identifier as a value in the controller flow table 3213 and adds a priority to the entry (step S343).

Next, the process query destination management means 3224 replaces the action corresponding to the entry registration instruction with a query to an arbitrary controller for a process (step S344).

Finally, the flow table operation means 1223 registers the entry in the flow table 325 (step S345).

(Advantageous Effects)

The communication system 1 according to the fourth exemplary embodiment provides advantageous effects similar to those provided by the communication system 1 according to the second and third exemplary embodiments. Namely, the switch 32 stores a query destination controller in the control flow table 3213, for an action querying a controller for a process in an entry in the flow table 325 according to the fourth exemplary embodiment. In this way, a controller to be queried for packet processing can be distinguished per flow range. As a result, for example, it is possible to determine a single controller controlling a certain flow.

In addition, each switch 32 stores authority information about controllers 11 per entry and limits operations on the entries in the flow table 325. In this way, each switch 32 limits the flow ranges that can be controlled by the controllers 11. Thus, unintended overwriting of a control policy by a different controller can be prevented.

With the above operation, a switch 32 can directly be controlled by a plurality of controllers 11 within a determined control range and authority range. Thus, according to the fourth exemplary embodiment, even when there are a plurality of controllers 11 controlling a switch 32, since it is possible to determine a single controller 11 controlling an incoming packet, control of a switch 32 by a plurality of controllers 11 can be achieved.

### Fifth Exemplary Embodiment

### Configuration

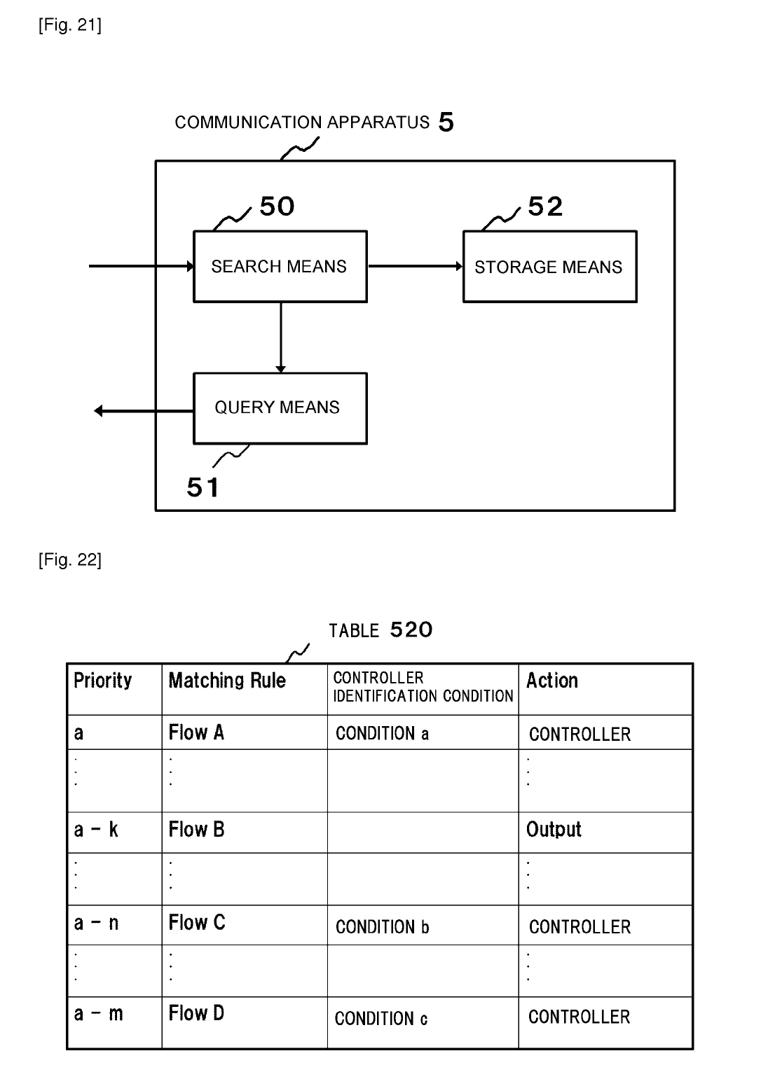

FIG. 21 illustrates a configuration example of a communication apparatus 5 according to a fifth exemplary embodiment.

The communication apparatus 5 includes a search means 50, a query means 51, and a storage means 52.

The communication apparatus 5 communicates with a plurality of controllers 11 and processes a packet in accordance with a control command from a controller 11.

The communication apparatus 5 is an apparatus having a communication function such as a mobile terminal, a mobile router, or a server or is a packet forwarding apparatus (such as a switch or a router) on a network. The mobile router is a relay terminal on a network such as a mobile phone 3G line or a wireless LAN. The communication apparatus 5 may be implemented as software on a mobile terminal, a mobile router, a server, or the like.

FIG. 22 illustrates a configuration example of a table 520 stored in the storage means 52. For example, each entry in the table 520 includes: a rule for identifying a packet (namely, a rule for identifying a flow to which a packet belongs); a controller identification condition for identifying a control apparatus (controller) that the communication apparatus 5 queries for a packet processing method; and a packet processing method corresponding to the rule. In FIG. 22, entries including “controller” in the “Action” field are entries in which a process for querying a controller is defined.

In the other exemplary embodiments (the first to fourth exemplary embodiments), if the process (“Action”) corresponding to an incoming packet is a process for querying a controller, the communication apparatus queries a controller designated in the “Action” section in the entry.

In the fifth exemplary embodiment, the communication apparatus 5 determines a controller 11 to be queried, in accordance with a controller identification condition included in an entry.

If “flow A” is described in a matching rule in FIG. 22, the matching rule′defines a condition for identifying a packet belonging to flow A. For example, a matching rule defines a condition that the source IP address is “x” and the destination IP address is “y.”

The search means 50 searches the table 520 in the storage means 52 for a process corresponding to an incoming packet. For example, the search means 50 checks the header of an incoming packet against the rules (matching rules) in the entries and searches for an entry corresponding to the incoming packet. If the search means 50 finds an entry corresponding to the incoming packet, the search means 50 processes the incoming packet in accordance with a processing method defined in the found entry. In accordance with the entry, the search means 50 forwards the incoming packet to a communication port of the communication apparatus 5, rewrites the header of the incoming packet, discards the incoming packet, or searches another table, for example.

The query means 51 communicates with at least one of a plurality of controllers 11. The query means 51 communicates with a controller 11 to query about an entry to be set in the table 520. In response to the query, the controller 11 determines an entry to be set in the communication apparatus 5 and notifies the communication apparatus 5 of the entry. The communication apparatus 5 stores the supplied entry in the table 520.

If the process found by the search means 50 is a process for querying a controller, the query means 51 determines a controller 11 to be queried from among a plurality of controllers, based on a predetermined area of the incoming packet.

The predetermined area of the incoming packet is the header field of the incoming packet. The search means 50 checks the predetermined area against the matching rules in the entries, to search for an entry corresponding to the incoming packet. If the found process is a process for querying a controller, the query means 51 determines a controller 11, based on information, which corresponds to a controller identification condition defined in the entry, in the predetermined area (for example, in the header field) of the incoming packet. For example, if a VLAN ID (Virtual Local Area Network ID) is defined as the controller identification condition, the query means 51 refers to the VLAN ID of the incoming packet, to determine a controller 11. The controller identification condition is not limited to a VLAN ID. An arbitrary condition may be set as the controller identification condition.

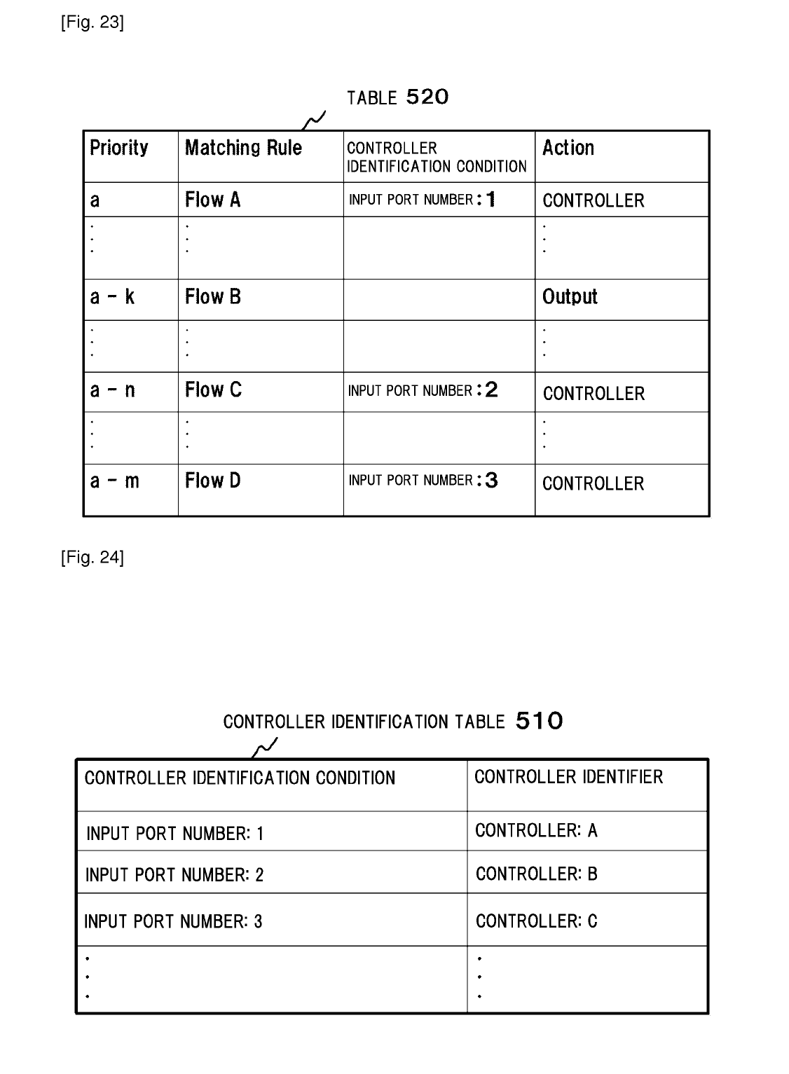

FIG. 23 illustrates the table 520 in which the controller identification condition is a packet ingress port.

In the first entry in FIG. 23, ingress port number 1 is defined as the controller identification condition, for packets belonging to flow A. In the first entry in FIG. 23, a process for querying a controller is defined as the process corresponding to flow A.

The query means 51 determines a controller 11, in accordance with information corresponding to the controller identification condition in the predetermined area of the incoming packet. In accordance with the controller identification condition, when the ingress port number of the incoming packet is “1,” the query means 51 queries a corresponding controller 11.

The query means 51 may include a controller identification table 510 managing the correspondence relationship between the controller identification condition and the query target controller identifier. If ingress port numbers are used as the controller identification condition, the query means 51 includes the controller identification table 510 managing a controller identifier for each port number. FIG. 24 illustrates the controller identification table 510.

The query means 51 extracts a controller identifier from the table 510 and queries a controller 11 corresponding to the identifier.

(Operation)

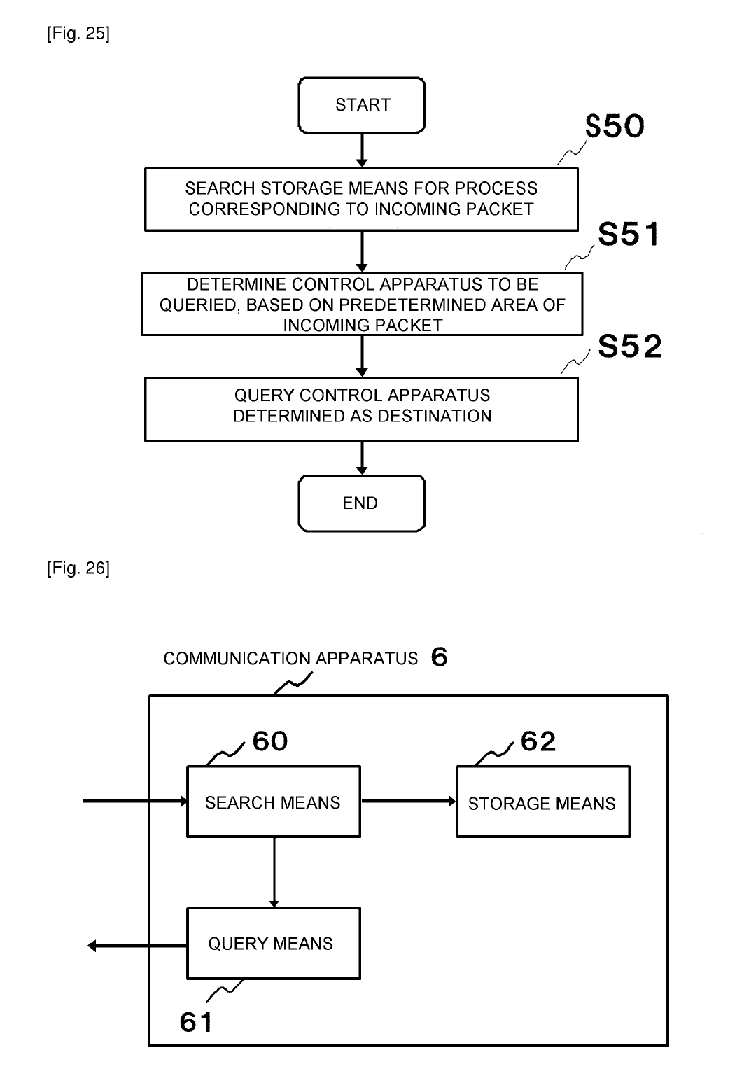

FIG. 25 is a flow chart illustrating an operation according to the fifth exemplary embodiment.

The communication apparatus 5 searches the storage means 52 for a process corresponding to an incoming packet (step S50).

If the found process is a process for querying a controller, the communication apparatus 5 determines a control apparatus to be queried from among a plurality of control apparatuses, based on information corresponding to the controller identification condition in the predetermined area of the incoming packet (step S51).

The communication apparatus 5 queries the determined control apparatus for a process to be executed on the incoming packet (step S52).

(Advantageous Effects)

The communication apparatus 5 according to the fifth exemplary embodiment determines a controller 11 to be queried, based on the predetermined area (the header field) in the incoming packet. Thus, if the controller 11 notifies the communication apparatus 5 of an entry including a process for querying a controller, the controller 11 only needs to designate a controller identification condition. Namely, the controller 11 does not need to designate a controller identifier. Thus, the communication apparatus 5 can flexibly change a controller corresponding to the controller identification condition.

### Sixth Exemplary Embodiment

### Configuration

FIG. 26 illustrates a configuration example of a communication apparatus 6 according to a sixth exemplary embodiment.

The communication apparatus 6 includes a search means 60, a query means 61, and a storage means 62.

The communication apparatus 6 communicates with a plurality of controllers 11 and processes a packet in accordance with a control command from a controller 11.

The communication apparatus 6 is an apparatus having a communication function such as a mobile terminal, a mobile router, or a server or is a packet forwarding apparatus (such as a switch or a router) on a network. The mobile router is a relay terminal on a network such as a mobile phone 3G line or a wireless LAN. The communication apparatus 6 may be implemented as software on a mobile terminal, a mobile router, a server, or the like.

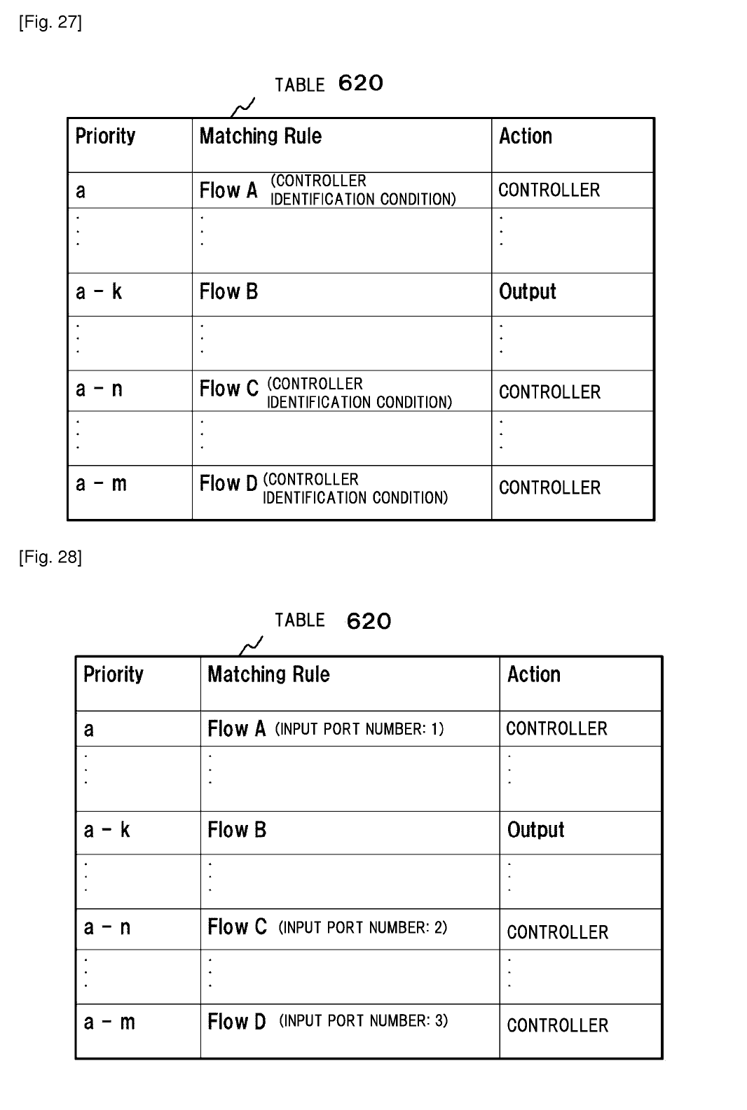

FIG. 27 illustrates a configuration example of a table 620 stored in the storage means 62. For example, each entry in the table 620 includes: a rule for identifying a packet (namely, a rule for identifying a flow to which a packet belongs); and a packet processing method corresponding to the rule. In FIG. 27, entries including “controller” in the “Action” field are entries in which a process for querying a controller is defined.

In the other exemplary embodiments (the first to fourth exemplary embodiments), if the process (“Action”) corresponding to an incoming packet is a process for querying a controller, the communication apparatus queries a controller designated in the “Action” section in the entry.

In the sixth exemplary embodiment, the communication apparatus 6 uses a condition (controller identification condition) included in a matching rule for identifying a packet, to determine a controller 11 to be queried. Namely, the communication apparatus 6 according to the sixth exemplary embodiment uses a part of a matching rule, to determine a controller 11 to be queried.

If “flow A” is described in a matching rule in FIG. 27, the matching rule defines a condition for identifying a packet belonging to flow A. For example, a matching rule defines a condition that the source IP address is “x,” the destination IP address is “y,” and the VLAN ID is “z.” In the sixth exemplary embodiment, the communication apparatus 6 uses a part of a matching rule (for example, the VLAN ID) as the controller identification condition.

The search means 60 searches the table 620 in the storage means 62 for a process corresponding to an incoming packet. For example, the search means 60 checks the header of an incoming packet against the rules (matching rules) in the entries and searches for an entry corresponding to the incoming packet. If the search means 60 finds an entry corresponding to the incoming packet, the search means 60 processes the incoming packet in accordance with a processing method defined in the found entry. In accordance with the entry, the search means 60 forwards the incoming packet to a communication port of the communication apparatus 6, rewrites the header of the incoming packet, discards the incoming packet, or searches another table, for example.

The query means 61 communicates with at least one of a plurality of controllers 11. The query means 61 communicates with a controller 11 to query about an entry to be set in the table 620.

If the process found by the search means 60 is a process for querying a controller, the query means 61 determines a controller 11 to be queried from among a plurality of controllers, based on a matching rule.

The matching rule in the table 620 includes the controller identification condition for identifying a controller. The query means 61 determines a controller 11 to be queried, based on the controller identification condition. The controller identification condition is the ingress port or the VLAN ID of the incoming packet, for example. However, the controller identification condition is not limited to the ingress port or the VLAN ID. An arbitrary condition may be set as the controller identification condition.

For example, assuming that a matching rule for identifying an incoming packet indicates a condition that values in fields A and B in the header of the incoming packet are “a” and “b,” respectively, and that region B is used as the controller identification condition, when the value in field B is “b,” the query means 61 queries a corresponding controller 11 for a process executed on the incoming packet.

FIG. 28 illustrates the table 620 in which the controller identification condition is a packet ingress port.

The first entry in FIG. 28 includes ingress port number “1,” as the condition for identifying packets belonging to flow A. In addition, the first entry in FIG. 28 defines a process for querying a controller, as the process corresponding to flow A.

The query means 61 uses the ingress port number as the controller identification condition, in the condition defined in the matching rule. If a packet belongs to flow A and the ingress port number is “1,” the query means 61 queries a corresponding controller 11.

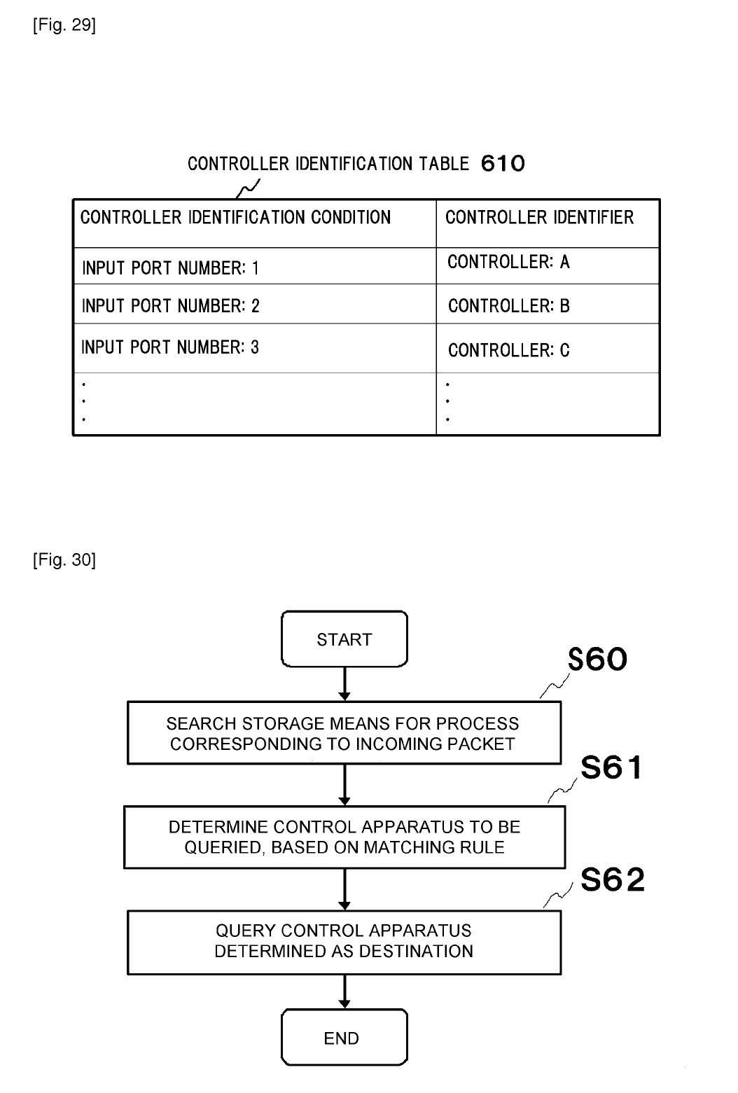

The query means 61 may include a controller identification table 610 managing the correspondence relationship between the controller identification condition and the query target controller identifier. For example, if ingress port numbers are used as the controller identification condition, the query means 61 includes the controller identification table 610 managing a controller identifier for each port number. FIG. 29 illustrates the controller identification table 610.

Based on a controller identification condition, which is a part of a matching rule, the query means 61 extracts the identifier of a corresponding controller from the table 610 and queries the controller 11 corresponding to the identifier.

(Operation)

FIG. 30 is a flow chart illustrating an operation example according to the sixth exemplary embodiment.

The communication apparatus 6 searches the storage means 62 for a process corresponding to an incoming packet (step S60).

If the found process is a process for querying a controller, the communication apparatus 6 determines a control apparatus to be queried from among a plurality of control apparatuses, based on the matching rule corresponding to the found process (step S61).

The communication apparatus 6 queries the determined control apparatus for a process to be executed on the incoming packet (step S62).

(Advantageous Effects)

The communication apparatus 6 according to the sixth exemplary embodiment uses a part of a matching rule to determine a controller 11 to be queried. Thus, the communication apparatus 6 according to the sixth exemplary embodiment can avoid addition of information for identifying a controller in an entry. Thus, with the communication apparatus 6 according to the sixth exemplary embodiment, the amount of entry information stored in the table can be reduced, counted as an advantageous effect.

### Seventh Exemplary Embodiment

### Configuration

Since the communication apparatus according to a seventh exemplary embodiment has the same configuration as that of the communication apparatus 6 according to the sixth exemplary embodiment, detailed description of the configuration will be omitted.

(Operation)

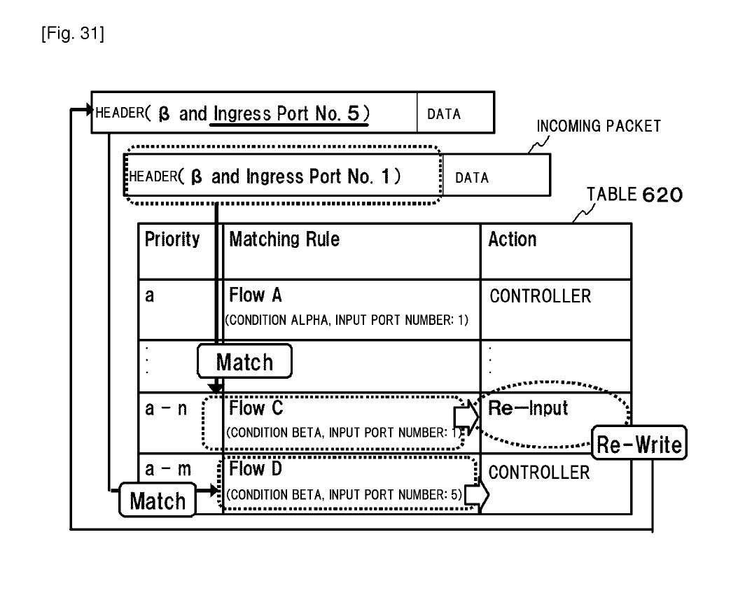

An operation example according to the seventh exemplary embodiment will be described with reference to FIG. 31. While ingress port numbers are used as the controller identification condition in FIG. 31, this is only an example. Namely, the controller identification condition is not limited to such ingress port numbers.

The search means 60 searches the storage means 62 for an entry corresponding to an incoming packet.

The following description will be made assuming that the incoming packet is inputted via port number 1 of the communication apparatus 6 and the predetermined area (header field) of the incoming packet matches condition beta that, for example, the source IP address is “a” and the destination IP address is “b.” Since the incoming packet is inputted via port number “1,” “1” is stored in “Ingress Port” in the header field.

Based on condition beta in the predetermined area of the incoming packet and ingress port number “1,” the search means 60 searches for an entry in which the matching rule is “Flow C.” The “Action” in the found entry defines an action “Reinput.” The action “Re-input” is a process for rewriting the header field of a packet matching the entry and searching the table again. In FIG. 31, the action “Re-input” defines rewriting the ingress port number in the header field of the incoming packet to “5” and searching the table again.

In accordance with the action “Re-input,” the search means 60 rewrites the ingress port number of the incoming packet to “5” and searches the table again.

As a result of this search operation, the search means 60 finds an entry in which the matching rule is “Flow D.” Since “Flow D” indicates that the matching rule is condition beta and the port number is “5,” the incoming packet whose header field has been rewritten matches this entry.

The “Action” defined in the entry in which the matching rule is “Flow D” is a process for querying a controller. Thus, the query means 61 queries a controller 11 corresponding to the ingress port number “5” for a process to be executed on the incoming packet.

An action for executing a re-search operation is described in the present exemplary embodiment. However, for example, a port searching for an inputted packet again may be used, and the packet may be outputted to the port. As in the example in FIG. 31, part of the matching rule is the same between Flow A and Flow C. Namely, in Flows A and C, the ingress port number, which is part of the matching rule, is “1.” However, other than the ingress port number, the matching rule is different in Flows A and C (Flows A and C indicate conditions alpha and beta, respectively).

In this case, while the matching rule other than the ingress port number differs, the query means 61 queries the same controller 11 about both packets belonging to Flow A and packets belonging to Flow C. This is because packets belonging to Flow A and packets belonging to Flow C correspond to the same ingress port number.

Since the matching rule other than the ingress port number differs, there are cases where it is preferable that the query means 61 query different controllers 11 about processes to be executed on packets belonging to Flow A and packets belonging to Flow C. In such cases, by using the action “Re-input” illustrated in FIG. 31, the query means 61 can query different controllers 11 about packets belonging to different flows in which only the controller identification condition is the same.

(Advantageous Effects)

In the seventh exemplary embodiment, the communication apparatus 6 can query different controllers 11 about packets belonging to different flows in which only the controller identification condition is the same. Thus, according to the seventh exemplary embodiment, a controller 11 queried for packet processing can be selected flexibly.

While the present invention has thus been described with reference to exemplary embodiments, the present invention is not limited thereto. Various variations conceivable by those skilled in the art can be made to the configurations or details of the present invention within the scope of the present invention. In addition, the present invention includes combinations of various exemplary embodiments.

Each of the switches according to the above exemplary embodiments can be applied to a communication terminal or another type of communication equipment as needed. The present invention is not limited to the above switches.

In addition, while a network using OpenFlow has been described in the above exemplary embodiments, the present inventions is not limited thereto. Other than OpenFlow, the present invention is applicable to an arbitrary network in which control servers or the like manage switches in a centralized manner.

In addition, each of the switches according to the above exemplary embodiments or a communication terminal or another type of communication equipment having functions equivalent to those of the switch can be realized by hardware. In addition, each of the switches according to the above exemplary embodiments or a communication terminal or another type of communication equipment having functions equivalent to those of the switch can be realized by a computer and a program executed on the computer. The program is recorded in a recording medium such as a magnetic disk or a semiconductor memory and is read by the computer when the computer is started, for example. In this way, the operation of the computer is controlled, and the computer is caused to serve as a switch according to any one of the above exemplary embodiments or a communication terminal or communication equipment having functions equivalent to those of the switch and to execute the above processing.

According to the present invention, the following modes are also possible.

(Mode 1)

A communication apparatus may be the communication apparatus according to the first aspect of the present invention.

(Mode 2)

In the communication apparatus, if the first means finds a process for querying a control apparatus, the second means may determine a control apparatus to be queried for a process corresponding to the incoming packet from among the plurality of control apparatuses, based on the predetermined area.

(Mode 3)

In the communication apparatus, the second means may determine a control apparatus to be queried for a process corresponding to the incoming packet, based on information used for identifying the plurality of control apparatuses, the information being included in the predetermined area.

(Mode 4)

In the communication apparatus, the second means may determine a control apparatus to be queried for a process corresponding to the incoming packet, based on at least one of the items of information included in the predetermined area.

(Mode 5)

In the communication apparatus,

by comparing the predetermined area included in the incoming packet with the rule, the first means may search the storage means for a process corresponding to the incoming packet, and

the second means may query a control apparatus corresponding to at least one of the items of information included in the predetermined area for a process corresponding to the incoming packet.

(Mode 6)

The communication apparatus may comprise:

a third means that rewrites a portion of the predetermined area and causes the first means to execute a search operation again, if the first means finds a process corresponding to the incoming packet.

(Mode 7)

In the communication apparatus, the second means may determine a control apparatus to be queried for a process corresponding to the incoming packet from among the plurality of control apparatuses, based on information matching the rule, the information being included in the predetermined area.

(Mode 8)

A communication method may be the communication method according to the second aspect of the present invention.

(Mode 9)

In the communication method, if a process for querying a control apparatus is found, a control apparatus to be queried for a process corresponding to the incoming packet may be determined from among a plurality of control apparatuses, based on the predetermined area.

(Mode 10)

In the communication method, a control apparatus to be queried for a process corresponding to the incoming packet may be determined, based on information used for identifying the plurality of control apparatuses, the information being included in the predetermined area.

(Mode 11)

In the communication method, a control apparatus to be queried for a process corresponding to the incoming packet may be determined, based on at least one of the items of information included in the predetermined area.

(Mode 12)

In the communication method,

by comparing the predetermined area included in the incoming packet with the rule, a process corresponding to the incoming packet may be found from the storage means, and

a control apparatus corresponding to at least one of the items of information included in the predetermined area may be queried for a process corresponding to the incoming packet.

(Mode 13)

The communication method may comprise rewriting a portion of the predetermined area and executing a search operation again, if a process corresponding to the incoming packet is found.

(Mode 14)

In the communication method, a control apparatus to be queried for a process corresponding to the incoming packet may be determined from among the plurality of control apparatuses, based on information matching the rule, the information being included in the predetermined area.

(Mode 15)

A communication system may be the communication system according to the third aspect of the present invention.

(Mode 16)

A program may be the program according to the fourth aspect of the present invention.

(Mode 17)

In the program, if a process for querying a control apparatus is found, a control apparatus to be queried for a process corresponding to the incoming packet may be determined from among a plurality of control apparatuses, based on the predetermined area.

(Mode 18)

In the program, a control apparatus to be queried for a process corresponding to the incoming packet may be determined, based on information used for identifying the plurality of control apparatuses, the information being included in the predetermined area.

(Mode 19)

In the program, a control apparatus to be queried for a process corresponding to the incoming packet may be determined, based on at least one of the items of information included in the predetermined area.

(Mode 20)

In the program,

by comparing the predetermined area included in the incoming packet with the rule, a process corresponding to the incoming packet may be found from the storage means, and

a control apparatus corresponding to at least one of the items of information included in the predetermined area may be queried for a process corresponding to the incoming packet.

The disclosures of the above Patent Literatures and Non-Patent Literature are incorporated herein by reference thereto. Modifications and adjustments of the exemplary embodiments are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

The term “means” used herein denotes a functional or operational unit performing the function of respective means, which may be implemented by hardware, software, or combination thereof. Thus, the term “means” may be expressed by the term “unit” throughout the entire disclosure.

### REFERENCE SIGNS LIST

1 communication system
11 controller
12, 32 switch
121, 321 control communication means (unit)
122, 222, 322 flow table management means (unit)
123 flow identification means (unit)
124 data processing means (unit)
125, 225, 325 flow table
1211 process query means (unit)
1221, 2221 authority management and determination means (unit)
1222 additional entry information storage means (unit)
1223 flow table operation means (unit)
3212 process query destination sorting means (unit)
3213 controller flow table
3224 process query destination management means (unit)
12211, 22211 entry operation authority management and determination means (unit)
12212, 22212 flow range determination means (unit)
5 communication apparatus
50 search means (unit)
51 query means (unit)
52 storage means (unit)
510 controller identification table
520 table
6 communication apparatus
60 search means (unit)
61 query means (unit)
62 storage means (unit)
610 controller identification table
620 table

1. A communication apparatus, comprising:
a storage unit that stores a rule for identifying a packet and a process to be executed on a packet corresponding to the rule;
a first unit that refers to a predetermined area in an incoming packet and searches the storage unit for a process corresponding to the incoming packet; and
a second unit that determines a control apparatus to be queried for a process corresponding to the incoming packet from among a plurality of control apparatuses, based on the predetermined area.

2. The communication apparatus according to claim 1, wherein
if the first unit finds a process for querying a control apparatus, the second unit determines a control apparatus to be queried for a process corresponding to the incoming packet from among the plurality of control apparatuses, based on the predetermined area.

3. The communication apparatus according to claim 1, wherein
the second unit determines a control apparatus to be queried for a process corresponding to the incoming packet, based on information used for identifying the plurality of control apparatuses, the information being included in the predetermined area.

4. The communication apparatus according to claim 1, wherein
the second unit determines a control apparatus to be queried for a process corresponding to the incoming packet, based on at least one of the items of information included in the predetermined area.

5. The communication apparatus according to claim 1, wherein
by comparing the predetermined area included in the incoming packet with the rule, the first unit searches the storage unit for a process corresponding to the incoming packet, and
the second unit queries a control apparatus corresponding to at least one of the items of information included in the predetermined area for a process corresponding to the incoming packet.

6. The communication apparatus according to claim 1, comprising:
a third unit that rewrites a portion of the predetermined area and causes the first unit to execute a search operation again, if the first unit finds a process corresponding to the incoming packet.

7. The communication apparatus according to claim 1, wherein
the second unit determines a control apparatus to be queried for a process corresponding to the incoming packet from among the plurality of control apparatuses, based on information matching the rule, the information being included in the predetermined area.

8. A communication method, comprising:
by a communication apparatus, storing a rule for identifying a packet and a process to be executed on a packet corresponding to the rule in a storage unit;
referring to a predetermined area in an incoming packet and searching the storage unit for a process corresponding to the incoming packet; and
determining a control apparatus to be queried for a process corresponding to the incoming packet from among a plurality of control apparatuses, based on the predetermined area.

9. The communication method according to claim 8, wherein
if a process for querying a control apparatus is found, a control apparatus to be queried for a process corresponding to the incoming packet is determined from among a plurality of control apparatuses, based on the predetermined area.

10. The communication method according to claim 8, wherein
a control apparatus to be queried for a process corresponding to the incoming packet is determined, based on information used for identifying the plurality of control apparatuses, the information being included in the predetermined area.

11. The communication method according to claim 8, wherein
a control apparatus to be queried for a process corresponding to the incoming packet is determined, based on at least one of the items of information included in the predetermined area.

12. The communication method according to claim 8, wherein
by comparing the predetermined area included in the incoming packet with the rule, a process corresponding to the incoming packet is found from the storage unit, and
a control apparatus corresponding to at least one of the items of information included in the predetermined area is queried for a process corresponding to the incoming packet.

13. The communication method according to claim 8, comprising:
rewriting a portion of the predetermined area and executing a search operation again, if a process corresponding to the incoming packet is found.

14. The communication method according to claim 8, wherein
a control apparatus to be queried for a process corresponding to the incoming packet is determined from among the plurality of control apparatuses, based on information matching the rule, the information being included in the predetermined area.

15. A communication system, comprising:
a plurality of control apparatuses; and
at least one communication apparatus according to claim 1.

16. A non-transitory computer-readable recording medium storing a program that causes a computer arranged on a communication apparatus to execute:
storing a rule for identifying a packet and a process to be executed on a packet corresponding to the rule in a storage unit;
referring to a predetermined area in an incoming packet and searching the storage unit for a process corresponding to the incoming packet; and
determining a control apparatus to be queried for a process corresponding to the incoming packet from among a plurality of control apparatuses, based on the predetermined area.

17. The non-transitory computer-readable recording medium according to claim 16, wherein
if a process for querying a control apparatus is found, a control apparatus to be queried for a process corresponding to the incoming packet is determined from among a plurality of control apparatuses, based on the predetermined area.

18. The non-transitory computer-readable recording medium according to claim 16, wherein
a control apparatus to be queried for a process corresponding to the incoming packet is determined, based on information used for identifying the plurality of control apparatuses, the information being included in the predetermined area.

19. The non-transitory computer-readable recording medium according to claim 16, wherein
a control apparatus to be queried for a process corresponding to the incoming packet is determined, based on at least one of the items of information included in the predetermined area.

20. The non-transitory computer-readable recording medium according to claim 16, wherein
by comparing the predetermined area included in the incoming packet with the rule, a process corresponding to the incoming packet is found from the storage unit, and
a control apparatus corresponding to at least one of the items of information included in the predetermined area is queried for a process corresponding to the incoming packet.
